(19) United States
(12) Patent Application Publication
(10) Pub. No.: US 2015/0003343 A1
(43) Pub. Date: Jan. 1, 2015

(54) NETWORK ASSISTED INTERFERENCE MITIGATION

(71) Applicant: Samsung Electronics Co., Ltd., Suwon-si (KR)

(72) Inventors: Yang Li, Plano, TX (US); Young-Han Nam, Plano, TX (US); Yan Xin, Princeton, NJ (US)

(21) Appl. No.: 14/316,215

(22) Filed: Jun. 26, 2014

Related U.S. Application Data
(60) Provisional application No. 61/841,080, filed on Jun. 28, 2013.

(51) Int. Cl. H04W 52/24; H04L 5/00

(52) U.S. Cl. CPC H04W 52/243; H04L 5/0073; H04L 5/005; H04W 88/08
USPC 370/329

(57) ABSTRACT

A method for network assisted interference mitigation includes identifying at least one pair of adjacent resource blocks within a same subframe. The at least one pair includes a low power resource block (RB) and a high power RB. The low power RB has a substantially lower beamforming gain compared to the high beamforming gain of the high power RB such that a ratio (R) comparing receive powers of the high power RB and the low power RB to each other is greater than a threshold ratio (μ). The method includes reducing a transmit power of the high power RE to a reduced transmit power level at which the ratio R is less than or equal to the threshold ratio μ (R≦μ).

### CROSS-REFERENCE TO RELATED APPLICATION(S) AND CLAIM OF PRIORITY

The present application claims priority to U.S. Provisional Patent Application Ser. No. 61/841,080, filed Jun. 28, 2013, entitled “NETWORK ASSISTED MITIGATION OF INTER-CARRIER INTERFERENCE (ICI) AND INTER-SYMBOL INTERFERENCE (ISI)”. The content of the above-identified patent document is incorporated herein by reference.

### TECHNICAL FIELD

The present application relates generally to wireless communication systems and, more specifically, to a network assisted interference mitigation within wireless communication systems.

### BACKGROUND

Cell-specific reference signals (CRS) and user equipment (UEs) or channels whose decoding relies on CRS are transmitted via a beam having a wide beamwidth, while the Physical Downlink Shared Channel (PDSCH) that relies on demodulation reference signal (DM-RS) can be transmitted via a beam having a narrow beamwidth. Therefore, the received power across resource elements (REs) in a UE can include high power dynamic range (for example, low power at CRS (and its sequential UEs or channels) and high power at DM-RS (its sequential PDSCH)). CRS and UEs or channels (e.g., physical broadcast channel, Physical Broadcast Channel (PBCH), or control channels) relying on CRS may not be received properly in the presence of frequency error, namely carrier frequency offset (CFO), if inter carrier interference (ICI) from substantially higher power PDSCH is intolerable.

### SUMMARY

To address the above-discussed deficiencies of the prior art, it is a primary object to provide a method, apparatus, and system for network assisted interference mitigation in a wireless communication network.

A method for network assisted interference mitigation is provided. The method includes identifying at least one pair of adjacent resource elements within a same subframe. The at least one pair includes a lower power resource block (RB) and a higher power RB. The lower power RB has lower power than the higher power RB such that a ratio (R) comparing receive powers of the higher power RB and the lower power RB to each other is greater than a threshold ratio (μ). The method includes reducing a transmit power of the higher power RB to a reduced transmit power level at which the ratio R is less than or equal to the threshold ratio μ (R≦μ).

A base station includes processing circuitry and a transmitter. The processing circuitry is configured to identify at least one pair of adjacent resource elements within a same subframe. The at least one pair includes an unprecoded resource block (RB) and a precoded RB. The unprecoded RB has a substantially lower beamforming gain compared to the high beamforming gain of the precoded RB such that a ratio (R) comparing receive powers of the precoded RB and the unprecoded RB to each other is greater than a threshold ratio (μ). The processing circuitry is also configured to reduce a transmit power of the precoded RB to a reduced transmit power level at which the ratio R is less than or equal to the threshold ratio μ (R≦μ). The transmitter is configured to transmit a signal using the reduced transmit power level.

A method includes identifying at least a first subframe (k). Each identified subframe includes a first resource block (RB) having high beamforming gain. The method includes configuring an advanced user equipment (UE) whether to expect a resource element guarding pattern to be ON or OFF in each RB in the first subframe.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network 100 that performs a network assisted interference mitigation process according to the embodiments of the present disclosure;

FIGS. 2A and 2B illustrate example wireless transmit and receive paths according to this disclosure;

FIG. 3 illustrates an example of a base station communicating with legacy UEs and advanced UEs in close spatial proximity to the legacy UEs according to embodiments of the present disclosure;

FIG. 4 illustrates a graphical example of coexistence of narrow beamwidth-high beamforming gain channels and broad beamwidth-low beamforming gain channels within the same UE according to embodiments of the present disclosure;

FIG. 5 illustrates an example of ICI resulting from unbalanced RE power and a high power dynamic range according to the present disclosure;

FIG. 6 illustrates a graph of signal to noise ratio (SNR) versus normalized frequency error (s) for various precoding scenarios according to the present disclosure;

FIG. 7 illustrates a graphical example of ICI for various subcarriers according to the present disclosure;

FIGS. 8A and 8B illustrate an example of RE guarding by RE muting, where the REs are muted or their power is reduced according to embodiments of the present disclosure;

FIGS. 9A and 9 B illustrate examples of performance of RE muting for SNR=10 dB according to embodiments of the present disclosure;

FIGS. 10A and 10B illustrate an example of RE guarding pattern for reducing interference to CSI-RS port;

FIGS. 11A and 11B illustrate examples of guard RE patterns for a FD-MIMO UE in the presence of a legacy UE transmitting two CRS ports according to embodiments of the present disclosure.

FIGS. 12A and 12B illustrate examples of RE guarding pattern for reducing interference to a CSI-RS port according to embodiments of the present disclosure;

FIGS. 13 and 14 illustrate examples of guard RE patterns of a subframe (k) for high beamforming resource blocks according to embodiments of the present disclosure;

FIG. 15 illustrates an example fixed RE muting and an example dynamic RE muting according to embodiments of the present disclosure;

FIG. 16 illustrates an example block diagram of a power control implementation and a RE guarding implementation according to embodiments of the present disclosure;

FIG. 17 illustrates an example of power control for different channels considering ICI according to embodiments of the present disclosure;

FIG. 18 illustrates an example of power control for different UEs considering ICI according to embodiments of the present disclosure; and

FIG. 19 illustrates an example of an RE blanking implementation according to embodiments of the present disclosure.

### DETAILED DESCRIPTION

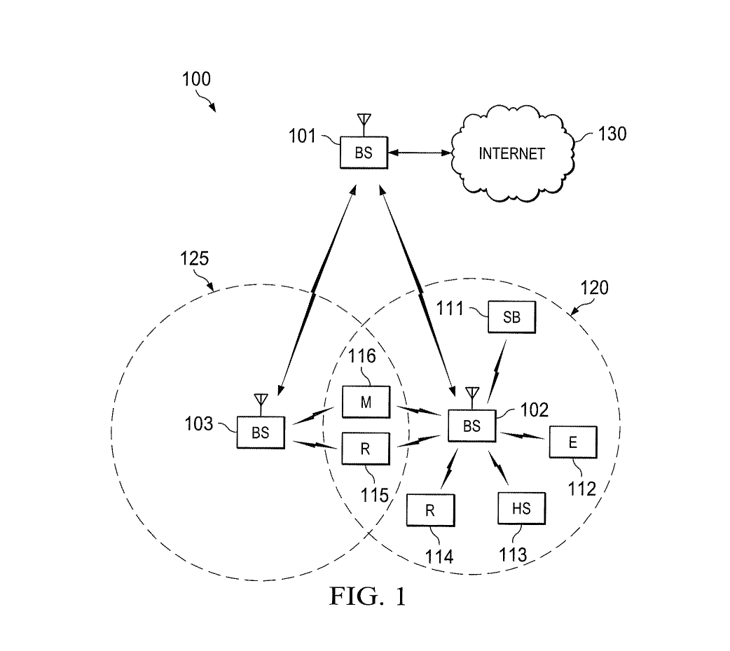

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

This disclosure provides resource element (RE) guarding methods to mitigate the inter-carrier interference (ICI) caused by carrier frequency offset (CFO). Although the present disclosure is disclosed in the context of the cellular band, the embodiments of this disclosure are applicable to other communication media, such as millimeter wave band. For illustration purposes, in this disclosure, the term “cellular band” is used to refer to frequencies around a few hundred megahertz to a few gigahertz, and the term “millimeter wave band” is used to refer to frequencies around a few tens of gigahertz to a few hundred gigahertz. The key distinction is that the radio waves in cellular bands have less propagation loss and can be better used for coverage purpose but may require large antenna size. On the other hand, radio waves in millimeter wave bands suffer higher propagation loss but lend themselves well to high-gain antenna or antenna array design in a small form factor.

Aspects, features, and advantages of the invention are readily apparent from the following detailed description, simply by illustrating a number of particular embodiments and implementations, including the best mode contemplated for carrying out the invention. The embodiments of this disclosure are also capable of other and different embodiments, and its several details can be modified in various obvious respects, all without departing from the spirit and scope of this disclosure. Accordingly, the drawings and description are to be regarded as illustrative in nature, and not as restrictive. In this disclosure, the figures of the accompanying drawings provide illustrations by way of example, and not by way of limitation. In this disclosure, the figures show a limited number and types of evolved Node B (eNBs) or limited number of UEs or limited number of connections or limited use cases as an example for illustration. However, the embodiments disclosed in this invention are also applicable to various numbers and types of base stations, a various number of mobile stations, a various number of connections, and other related use cases.

FIG. 1 illustrates a wireless network 100 that performs a network assisted interference mitigation process according to the embodiments of the present disclosure. The embodiment of the wireless network 100 shown in FIG. 1 is for illustration only. Other embodiments could be used without departing from the scope of this disclosure.

The wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of mobile stations within coverage area 120 of base station 102. The first plurality of mobile stations includes mobile station 111, which can be located in a small business (SB), mobile station 112, which can be located in an enterprise (E), mobile station 113, which can be located in a WiFi hotspot (HS), mobile station 114, which can be located in a first residence (R), mobile station 115, which can be located in a second residence (R), and mobile station 116, which can be a mobile device (M), such as a cell phone, a wireless laptop, a wireless PDA, or the like.

Base station 103 provides wireless broadband access (via base station 101) to Internet 130 to a second plurality of mobile stations within coverage area 125 of base station 103. The second plurality of mobile stations includes mobile station 115 and mobile station 116. As an example, base stations 101-103 communicate with each other and with mobile stations 111-116 using orthogonal frequency division multiple (OFDM) or orthogonal frequency division multiple access (OFDMA) techniques.

Base station 101 can be in communication with either a greater number or a lesser number of base stations. Furthermore, while only six mobile stations are depicted in FIG. 1, it is understood that wireless network 100 can provide wireless broadband access to additional mobile stations. It is noted that mobile station 115 and mobile station 116 are located on the edges of both coverage area 120 and coverage area 125. Mobile station 115 and mobile station 116 each communicate with both base station 102 and base station 103 and can be said to be operating in handoff mode, as known to those of skill in the art.

Mobile stations 111-116 access voice, data, video, video conferencing, and/or other broadband services via Internet 130. In an exemplary embodiment, one or more of mobile stations 111-116 is associated with an access point (AP) of a WiFi WLAN. Mobile station 116 can be any of a number of mobile devices, including a wireless-enabled laptop computer, personal data assistant, notebook, handheld device, or other wireless-enabled device. Mobile stations 114 and 115 can be, for example, a wireless-enabled personal computer (PC), a laptop computer, a gateway, or another device.

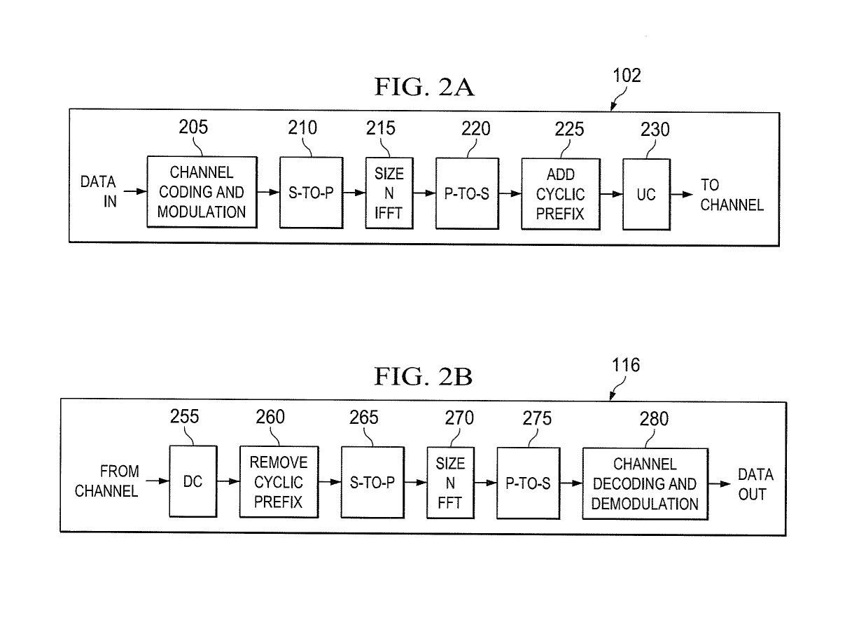

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in mobile station (MS) 116 for the purposes of illustration and explanation only. However, it will be understood by those skilled in the art that the OFDMA receive path also can be implemented in BS 102 and the OFDMA transmit path can be implemented in MS 116.

The transmit path in BS 102 includes channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in MS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B can be implemented in software while other components can be implemented by configurable hardware or a mixture of software and configurable hardware. In particular, it is noted that the FFT blocks and the IFFT blocks described in this disclosure document can be implemented as configurable software algorithms, where the value of Size N can be modified according to the implementation.

In BS 102, channel coding and modulation block 205 receives a set of information bits, applies LDPC coding and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and MS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal can also be filtered at baseband before conversion to RF frequency.

The transmitted RF signal arrives at MS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes (i.e., performs LDPC decoding) the modulated symbols to recover the original input data stream.

Each of base stations 101-103 implement a transmit path that is analogous to transmitting in the downlink to mobile stations 111-116 and implement a receive path that is analogous to receiving in the uplink from mobile stations 111-116. Similarly, each one of mobile stations 111-116 implement a transmit path corresponding to the architecture for transmitting in the uplink to base stations 101-103 and implement a receive path corresponding to the architecture for receiving in the downlink from base stations 101-103.

The channel decoding and demodulation block 280 decodes the received data. The channel decoding and demodulation block 280 includes a decoder configured to perform a network assisted interference mitigation operation.

In future wireless communication, extremely directional beamforming can be implemented e.g. via full-dimension multiple input multiple output (FD-MIMO) or fifth generation (5G) millimeter wave (mmWave) to improve the spectrum efficiency and to enable high order multiple user MIMO (MU-MIMO). Such precoding or beamforming is supported by non-codebook based precoding in 3GPP LTE-Advanced standards, and does not require signaling of the precoders as long as the same precoders are applied to the demodulation reference signal (DM-RS). Meanwhile, cell-specific reference signals (CRS) and user equipment (UEs) or channels (e.g., physical broadcast channel (PBCH), or control channels) relying on CRS cannot be transmitted via narrow beams, otherwise they cannot be received properly. Some resource elements (REs) are precoded or narrowly beamformed and thus have extremely high power, while some other REs are transmitted via wide beam and thus have small power. As a result, UEs may potentially operate with a high dynamic range of power.

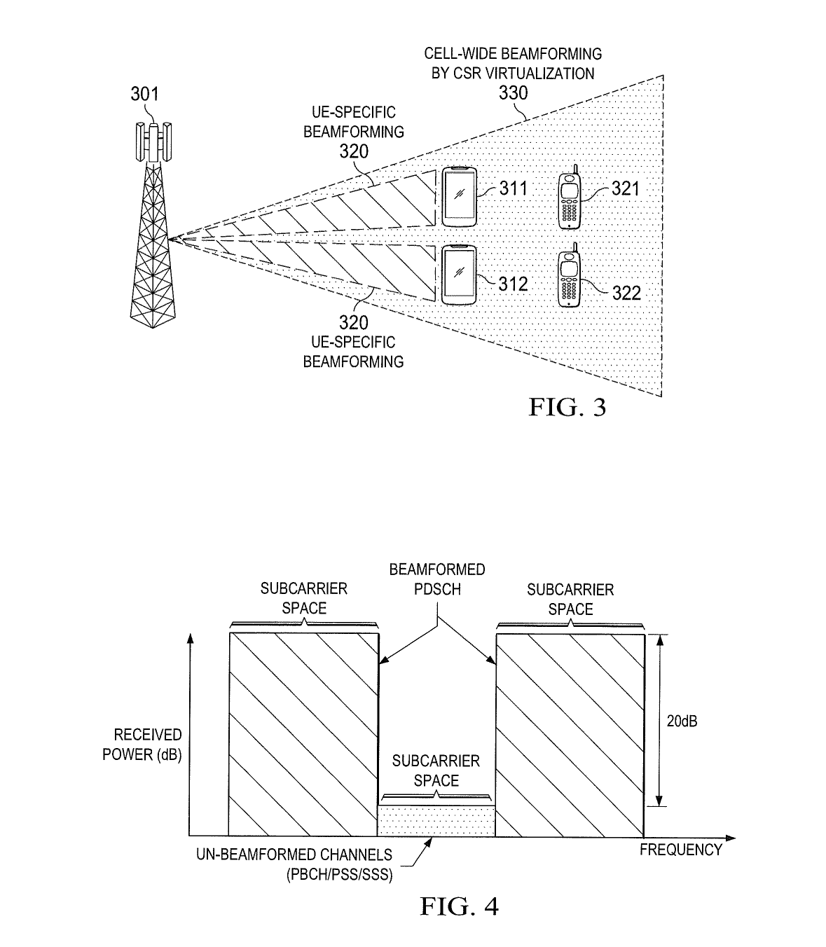

FIG. 3 illustrates an example of a base station communicating with legacy UEs and advanced UEs in close spatial proximity to the legacy UEs according to embodiments of the present disclosure. The embodiment shown in FIG. 3 is for illustration only. Other embodiments could be used without departing from the scope of this disclosure.

FIG. 3 shows an example of advanced UEs 311 and 312 that support FD-MIMO operation communicating with a same cell as legacy UEs 321 and 322 that rely on CRS to decode Physical Downlink Control Channel (PDCCH) or estimate the channel followed by decoding. The base station 301 communicates with the advanced UEs 311-312 by transmitting signals 320 with precoding using UE-specific beamforming. The base station 301 communicates with the legacy UEs 321-322 by transmitting a signal 330 without precoding using cell-specific beamforming. When advanced UEs 311-312 are in close physical proximity to the legacy UEs 321-322, the legacy UEs may receive strong power in the REs assigned to advanced UEs 311-312 due to the correlation among their channels. In this case, the high power beamforming operation of advanced UEs 311-312 may cause severe interference to the legacy UEs 321-322.

FIG. 4 illustrates a graphical example of coexistence of narrow beamwidth-high beamforming gain channels and broad beamwidth-low beamforming gain channels within the same UE according to embodiments of the present disclosure. The embodiment shown in FIG. 4 is for illustration only. Other embodiments could be used without departing from the scope of this disclosure.

Specifically, a UE's PDSCH channel is precoded with narrow beamforming that may lead to a high receive power, while the UE's PBCH channel and synchronization signals (e.g., Primary Synchronization Signal (PSS) or Secondary Synchronization Signal (SSS)) are transmitted with wide beamwidth that may lead to a low power. This UE may receive a high dynamic range of power, namely, the received power of the narrow beamwidth-high beamforming gain PDSCH is (for example, 20 decibels (dB)) greater than the broad beamwidth-low beamforming gain channels. The high receive power of the precoded or high power channel may severely interfere with the low power channels of the UE. New methods are needed to ensure all (advanced UEs 321-322 and legacy UEs 311-312) the UEs or channels can be received properly.

Inter-carrier interference (ICI) is one of the problems of a UE having a high power dynamic range. Most of wireless systems rely on orthogonal frequency division multiplexing (OFDM) and are subject to frequency error and inter-carrier interference (ICI). UEs are subject to frequency error caused by Doppler, phase noise and inaccuracy of local oscillators. Frequency error (namely, carrier frequency offset (CFO)) causes ICI. In the presence of CFO, the received signal at the kth subcarrier can be expressed by Equation 1:

yₖ=XₖS_{O}+Σ_{l=0,l≠k}^{N-1}Sₗ₋ₖXₗ+nₖ, for k=0,1, . . . ,N−1. (1)

where Xₖ is the high power signal in the kth subcarrier, N is the total number of subcarriers and the terms in the summation are interference. In Equation 1,

$${S}_{k} = \frac{sin π ( k + ɛ )}{N sin \frac{π}{N} ( k + ɛ )} {e}^{- j π ( 1 - \frac{1}{N} ) ( k + ɛ ) } \qquad ( 2 )$$

The value of Sₖ depends on the value of a normalized CFO (ε). Typically, in LTE systems (or any OFDM based systems) ε must be maintained sufficiently small so that the degradation of interference is tolerable. Current 3GG RAN 4 specifies a UE shall have frequency accuracy of ±0.1 PPM (i.e., ±10⁻⁷), which corresponds to ε shown in Table 1.

TABLE 1
Normalized frequency error under different carrier frequency and
subcarrier spacing

| Carrier Freq. | | Normalized | Subcarrier space |
|---|---|---|---|
| (GHz) | Freq. error (Hz) | Freq. error (ε) | (kHz) |
| 2 | 200 | 1.3% | 15 |
| 3.5 | 350 | 2.3% | 15 |
| 28 | 2800 | 1.8% | 150 |
| 60 | 6000 | 4% | 150 |

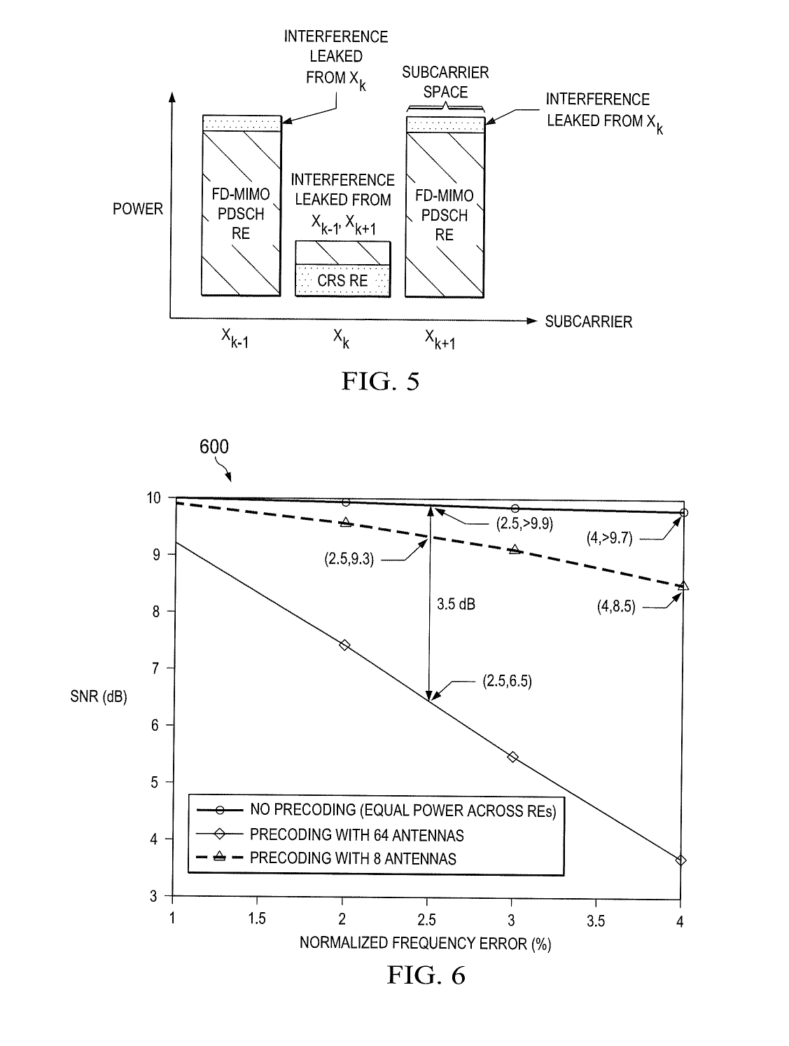

In cases of a high power dynamic range, the requirement of ±0.1 PPM may not be sufficient to prevent severe interference. For example, a legacy UE, such as UE 321-322, can tolerate a ε≦1%, which means that for a 15 kHz subcarrier space, the frequency error must not exceed 150 Hz, yet under the 3GG RAN 4 specification, a 2 GHz carrier frequency corresponds to s=1.3% and frequency error of 200 Hz (i.e., ±10⁻⁷×2×10⁹ Hz=±200 Hz), which may be intolerable to the legacy UE. FIG. 5 illustrates an example of ICI resulting from unbalanced RE power and a high power dynamic range according to the present disclosure. The subcarrier Xₖ (e.g., CRS RE) is low powered, and the adjacent REs (Xₖ₋₁, Xₖ₊₁) are high powered. In this disclosure, the term high power refers to a resource element having high beamforming gain; and the term low power refers to a resource element having low beamforming gain. At the receiver side, the power of the received signal of the low power subcarrier Xₖ is substantially less than the received power of an adjacent subcarrier (X_{k±1}>>Xₖ) that is a high power RE. Even with small ε the ICI experienced by the subcarrier Xₖ is significant. For example, the amount of received power of the interference leaked from adjacent subcarriers (Xₖ₋₁ and Xₖ₊₁) is nearly as much as the amount of received power of the CRS RE signal itself. In this case, even if only a small percentage of power is leaked from (Xₖ₋₁, Xₖ₊₁), the leakage causes significant interference to Xₖ, as the signal-to-noise-and-interference (SINR) ratio may be too low for reliable decoding for the information carried in the subcarrier Xₖ. Such degradation may introduce significant throughput loss for the UEs relying on CRS to decode or estimate its channel, and thus must be accounted for and mitigated effectively. The amount of received power of the interference leaked from the low power subcarrier (Xₖ) is significantly less than the amount of received power of the individual FD MIMO PDSCH REs.

FIG. 6 illustrates a graph of signal to noise ratio (SNR) versus normalized frequency error (c) for various precoding scenarios according to the present disclosure. The embodiment shown in FIG. 6 is for illustration only. Other embodiments could be used without departing from the scope of this disclosure.

The graph 600 shows SNR degradation in the presence of precoding and quantifies the impact of frequency error under evenly distributed power and high power dynamic range. Three scenarios are shown, including a scenario of no precoding, a scenario of precoding using sixty-four (64) transmit antennas, and a scenario of precoding using eight (8) transmit antennas. In case of no precoding (shown as a hollow circle marked curve), the an equal amount of power is transmitted to the REs, and the SNR degradation is less than 0.3 dB even if ε=4%. In the presence of precoding (shown as a hollow triangle marked curve) with 8 antennas (a beamforming gain 8 times), the SNR degradation for low power REs is 1.5 dB when ε=4% and 0.7 dB when ε=2.5%. When the number of transmit antennas is 64 (e.g., FD-MIMO or mmWave) (maximum 64 times beamforming gain), the SNR degradation for low power REs is 3.5 dB when ε=2.5%, much more severe than current 8 antenna LTE system or low power system. Degradation of the SNR increases significantly with an increase in beam forming gain (i.e., increase in number of transmit antennas).

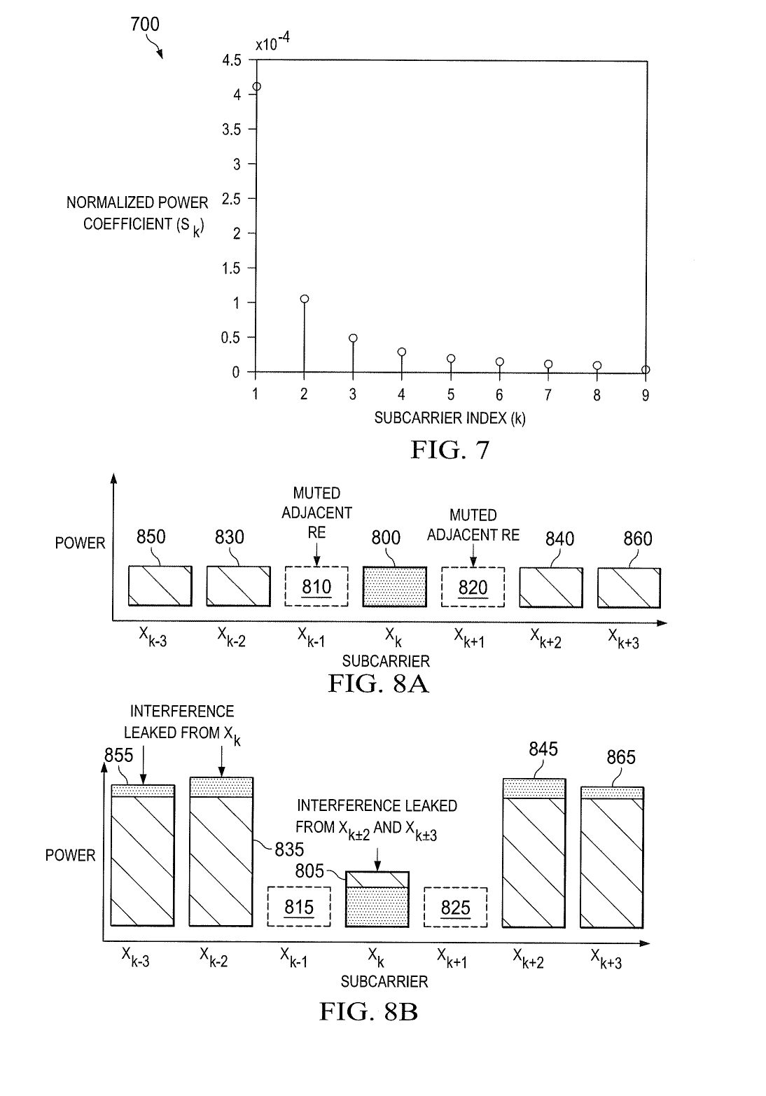

FIG. 7 illustrates a graphical example of ICI for various subcarriers according to the present disclosure. The embodiment shown in FIG. 7 is for illustration only. Other embodiments could be used without departing from the scope of this disclosure.

In FIG. 7, the coefficient Sₖ is plotted where ε=2%. The graph 700 show normalized power coefficient (Sₖ) versus subcarrier index. The subcarrier index (k) for a subcarrier of interest is zero (i.e., k=0), and the adjacent subcarrier indices are positive and negative one (i.e., k=1 and k=−1). For simplicity, subcarrier of interest (Xₖ₌₀) is not shown in the graph, yet only positive subcarrier indices are shown. The negative subcarrier indices are a mirror image reflection of the positive subcarrier indices. That is, the normalized power coefficient for subcarrier indicies −1, −2, and −3 are the equivalent to the normalized power coefficient for subcarrier indices 1, 2, and 3, respectively. As shown, the Sₖ of adjacent REs (Xₖ₌₁ and Xₖ₌₋₁) dominates over REs that are non-adjacent and further away (X_{k±2} and X_{k±3}). From the amount of interference leaked decays exponentially as the further way an interfering subcarrier is located from the subcarrier of interest. That is, subcarrier X₀ receives exponentially less interference from subcarrier X₃ than from X₂. Also, subcarrier X₀ contributes exponentially more interference to subcarrier X₂ than to X₃.

### Network Assisted Interference Mitigation

In this disclosure, the base-station 301 configures the power allocation of different UEs so that the interference will be reduced at the UE side. For example, the base-station can mute (or reduced the power) the high power REs adjacent to a low power RE. The graph 700 shows that most of the interference (approximately 50%) is from the adjacent REs (i.e., subcarrier indices 1 and −1). Accordingly, limiting the power of the adjacent REs will effectively reduce the interference received at the RE of interest (Xₖ). A guard band in the time domain will reduce interference.

FIGS. 8A and 8A illustrates an example of RE guarding by RE muting, where the REs are muted or their power is reduced according to embodiments of the present disclosure. The embodiments of the RE guarding by RE muting shown in FIGS. 8A and 8B are for illustration only. Other embodiments could be used without departing from the scope of this disclosure. FIG. 8A illustrates amounts of power of transmitted signals for various subcarriers. FIG. 8B illustrates amounts of power of received signals for various subcarriers, where the received signals where transmitted in FIG. 8A.

At the transmitter side, the two high power REs 810 and 820 adjacent to the low power (e.g., CRS) REs 800 are muted, (e.g., setting power to be zero). At the receiver side, because of the precoding, the low power CRS RE's 805 power level is much lower than the power level of high power REs 815 and 825. Because the two adjacent REs are muted, no interference is caused by the adjacent REs; only the REs 835, 845, 855, 865 that are further away (X_{k±2} and X_{k±3}) will cause interference, which is small according to FIG. 7. That is, the normalized power coefficient values (Sₖ) of FIG. 7 can represent power levels of the subcarriers in FIGS. 8A and 8B.

The amount of power of the received signal 805 for subcarrier Xₖ is the sum of power received from the low power (shown in light shading) transmitted signal 800, the power received from the interference leaked from the high power (shown in dark shading) received signals 835, 840, 850, and 860. For subcarrier Xₖ, the received power of attributable to the low power signal is substantially greater than the received power attributable to leakage from the high power signals.

The amount of power of the received signal 835 for subcarrier Xₖ₋₁ is the sum of power received from the high power (shown in dark shading) transmitted signal 830, the power received from the interference leaked from the low power (shown in light shading) received signal 805. For subcarrier Xₖ₋₁, the received power of attributable to the high power signal 830 is substantially greater than the received power attributable to leakage from the low power signal 805. Also, as the low power subcarrier Xₖ is non-adjacent and further from the subcarrier Xₖ₋₂ than from subcarrier Xₖ₋₁, the amount of interference leaked from Xₖ to Xₖ₋₁ is exponentially greater than the amount of interference leaked from Xₖ to Xₖ₋₂.

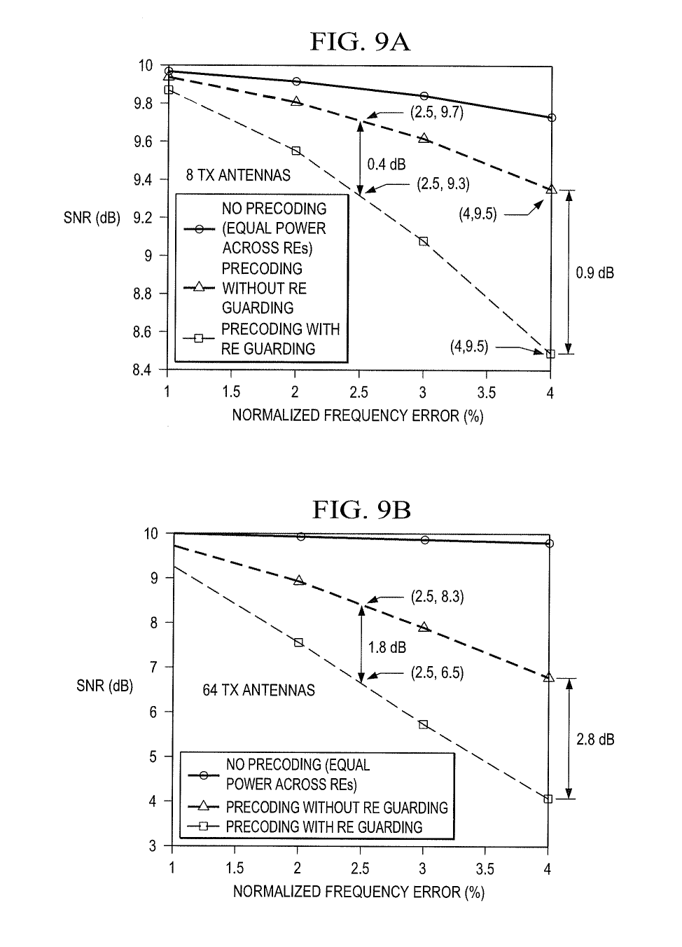

FIGS. 9A and 9 B illustrate examples of performance of RE muting for SNR=10 dB according to embodiments of the present disclosure. The embodiments of RE muting shown in FIGS. 9A and 9B are for illustration only. Other embodiments could be used without departing from the scope of this disclosure

FIG. 9A illustrates a graph of signal to noise ratio (SNR) for 8 transmit antennas versus normalized frequency error (ε) for various precoding and RE guarding scenarios. FIG. 9A illustrates a graph of signal to noise ratio (SNR) for 64 transmit antennas versus normalized frequency error (ε) the same precoding and RE guarding scenarios as FIG. 9A. Three scenarios are shown, including a scenario of no precoding, a scenario of precoding without using RE guarding, and a scenario of precoding using RE guarding.

A comparison of FIG. 6 to FIGS. 9A and 9B shows that RE guarding considerably reduces the interference and SNR loss, where adjacent REs are muted. At 2.5% CFO, the RE guarding by RE muting according to the present disclosure obtains SNR gain 0.4 dB with 8 transmit antennas, and in the range of 1.8 dB to 2 dB with 64 transmit antennas. At ε=4.0%, the RE muting according to embodiments of this disclosure obtains SNR gains in the range of 0.9 dB to 1.0 dB with 8 transmit antennas, and in the range of 2.6 to 2.8 dB with 64 transmit antennas. As the number of antennas increases, the SNR gain of RE guarding viability increases. RE guarding by muting adjacent REs can provide approximately 3 dB of gain.

Embodiments of the present disclosure are simple and do not require complex UE or eNB processing, compared with other methods. For example, in frequency equalization methods, a UE has to apply a complex algorithm to equalize the channels to reduce the interference. Another method is self-cancellation, which requires an eNB to know the channel response in advance to pre-equalize the channel. Benefits of embodiments of the present disclosure can be realized and implemented without impacting the current standards.

### RE Guarding Pattern

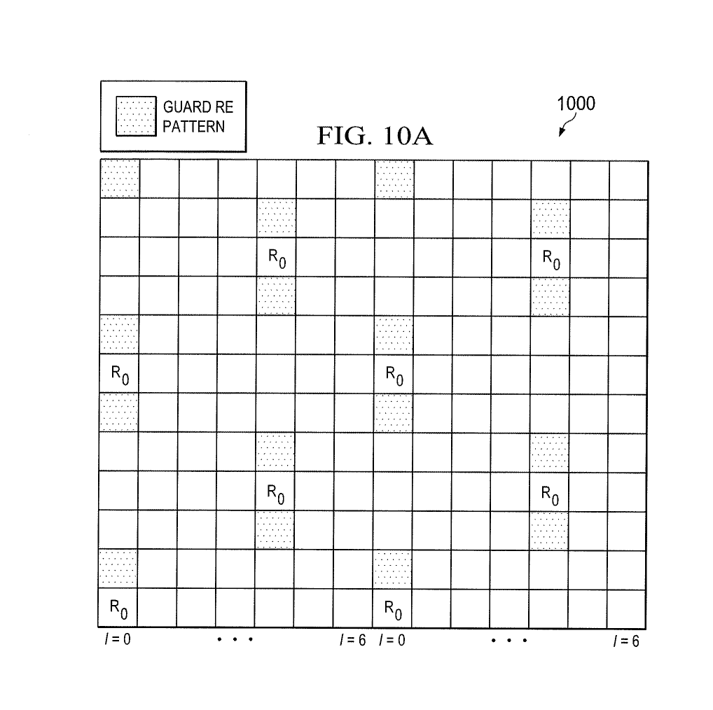

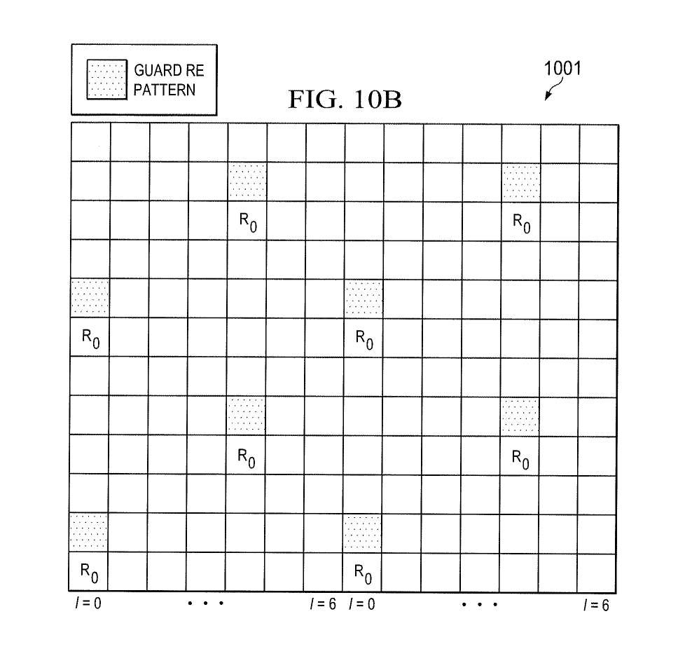

FIGS. 10A and 10B illustrate an example of guard RE patterns for an advanced UE in the presence of a legacy UE transmitting one CRS port according to embodiments of the present disclosure. The embodiments of the guard RE patterns shown in FIGS. 10A and 10B are for illustration only. Other embodiments could be used without departing from the scope of this disclosure.

The base station 301 reduces the power or completely mutes some REs (called guard REs) in a resource block (RB) so that the ICI to other REs may be reduced. The proposed method is named as RE guarding. There is a tradeoff between the ICI reduction (SINR gain) by RE guarding and the overall system throughput. In this disclosure, the REs that used to carry information are now selected as guard REs and they are either muted (transmitted at zero power) or carry reduced power signals.

The selection of guard REs requires careful designs as it will reduce the data rate that can be carried by RB. Within a RB, the base station 301 selects a few REs as guard REs, time-frequency mapping of the selected guard REs within a RB is called a “RE guarding pattern.” An increase in the number of REs to be included in a RE guarding pattern cause less ICI (and higher SINR) for the other REs in this RB.

RE guarding may primarily apply to DM-RS port(s) transmission. For example, when an eNB is transmitting PDSCH on a DM-RS port (e.g., 3GPP LTE downlink antenna port 7/8 for an advanced UE), the eNB may use the RE guarding, so that the interference to CRS RE received at another UE can be reduced.

FIGS. 10A and 10B show RE guarding patterns for reducing interference to a CRS port. In a case of 1 CRS port, two RB patterns can be considered. FIG. 10A illustrates a first RB pattern 1000 (1P−1) that includes two adjacent REs (dark-shaded) for every CRS REs (light shaded, marked with a value R₀). FIG. 10B illustrates a second pattern 1001 (1P−2) that only includes 1 adjacent RE (dark-shaded) for every CRS REs (light shaded, marked with a value R₀). With the pattern 1000 (1P−1), ICI is smaller than that in pattern 1001 (1P−2), but the pattern 1000 (1P−1) has higher loss in available REs for PDSCH. In practice, the base station 301 can choose among two patterns depending on the requirement on interference as well as the overall throughput requirement.

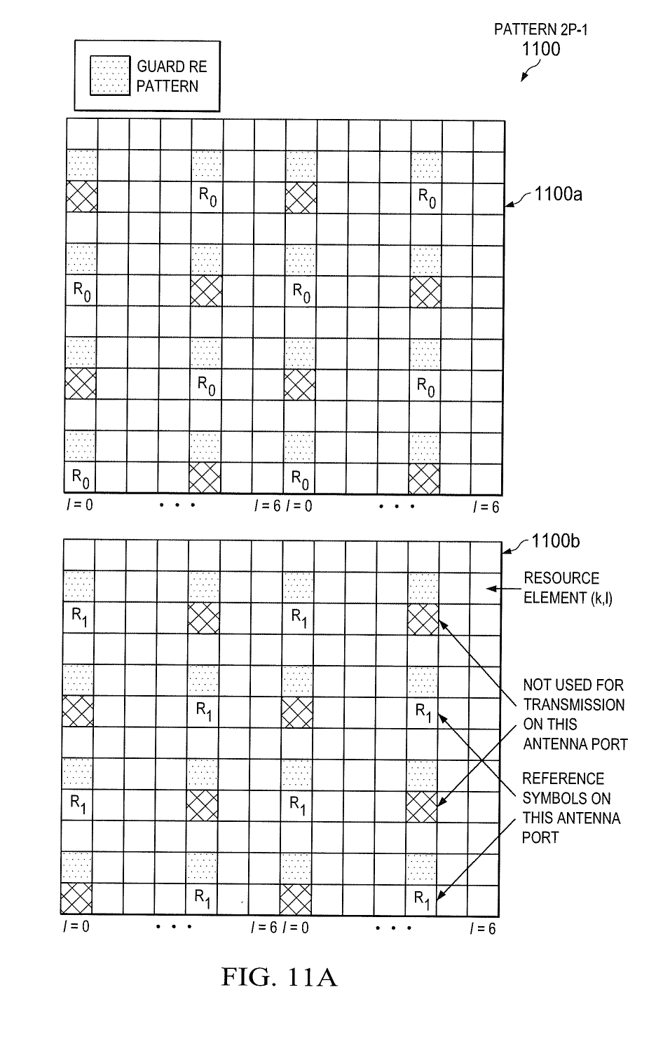

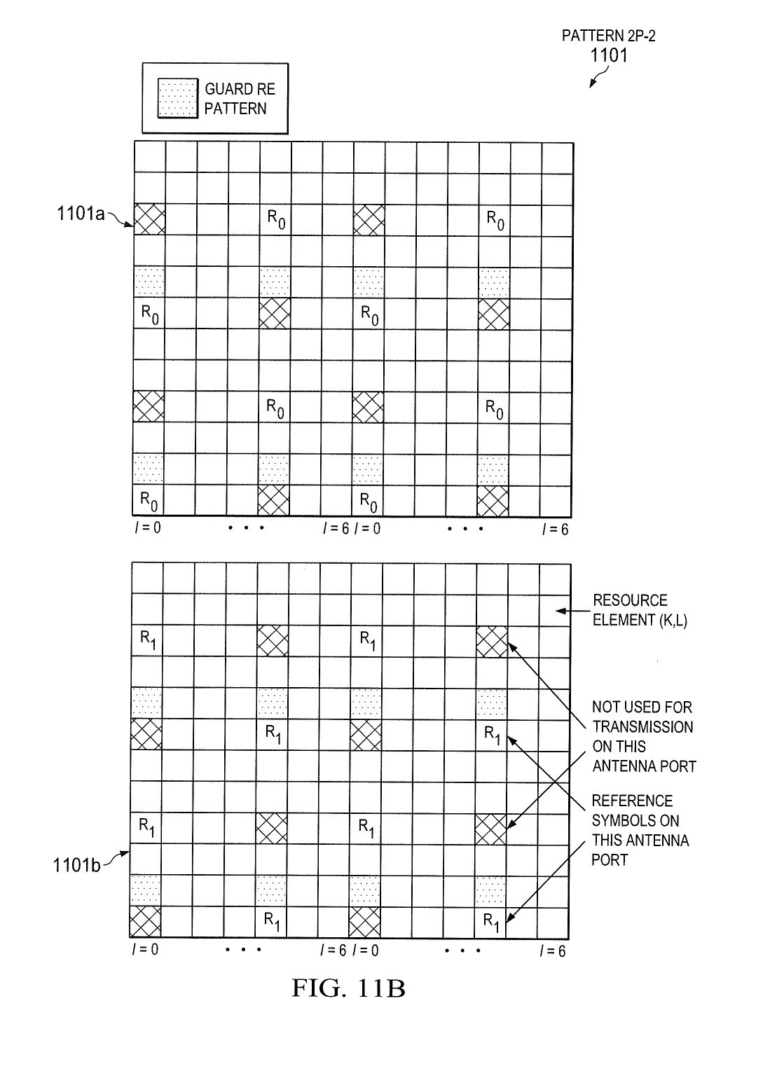

FIGS. 11A and 11B illustrate examples of guard RE patterns for an advanced UE in the presence of a legacy UE transmitting two CRS ports according to embodiments of the present disclosure. The embodiments of the guard RE patterns shown in FIGS. 11A and 11B are for illustration only. Other embodiments could be used without departing from the scope of this disclosure.

In a case of 2 CRS ports, two patterns are considered. FIG. 11A illustrates the first pattern 1100 (2P−1) that includes one adjacent (dark-shaded) REs for every CRS RE (light shaded, marked with a value R₀ for a first CRS port and marked with a value R₁ for a second CRS port). In the first pattern 1100, RB pattern 1100a for the CRS REs of the first CRS port (light shaded, marked with a value R₀) are not used for transmission on the antenna port in the RB pattern 1101b for the second CRS port. Vice versa, in the second pattern 1101, the REs (marked R₁ for the value within the resource element) used for transmission in RB pattern 1101a are not used for transmission in the RB pattern 1101b.

FIG. 11B illustrates the second pattern 1101 (2P−2), where the base station 301 mutes one RE (dark-shaded) for every CRS port 1 and CRS port 2 in OFDM symbol 0, 7 and 4, 11, respectively. It is a technical advantage to provide multiple choice to balance the ICI reduction and data RE loss. The first CRS port is transmitted according to the RB pattern 1101a; and the second CRS port is transmitted according to the RB pattern 1101b, where certain REs (cross hatched) are not used for transmission on the antenna port used to transmits the CRS port 1 (light shaded, marked R₀). Information throughput is reduced corresponding to the REs that are not used for transmission.

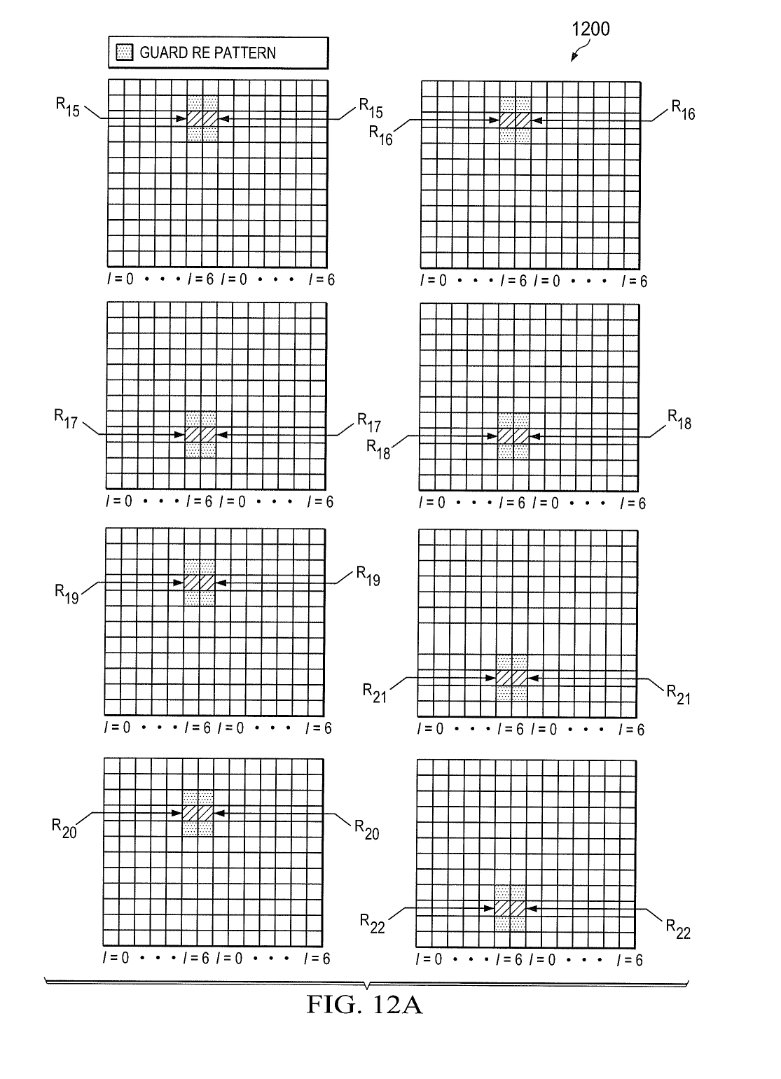

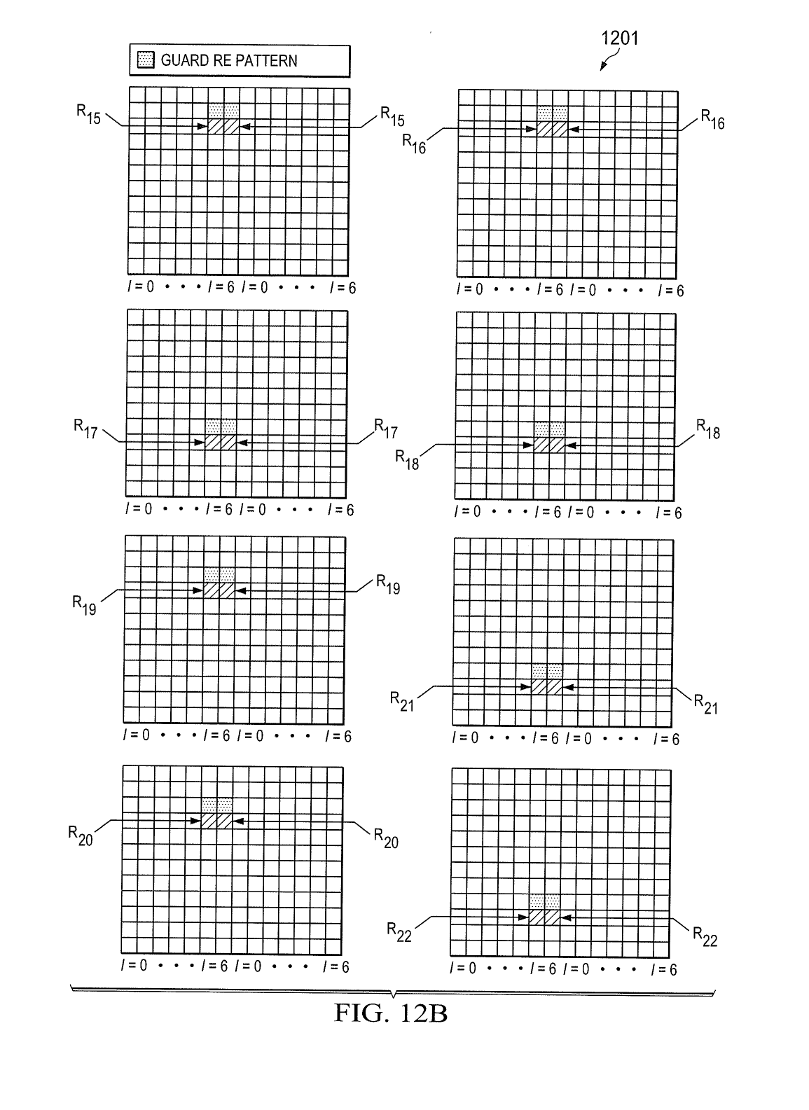

FIGS. 12A and 12B illustrate examples of RE guarding pattern for reducing interference to a CSI-RS port according to embodiments of the present disclosure. The embodiments of the guard RE patterns shown in FIGS. 12A and 12B are for illustration only. Other embodiments could be used without departing from the scope of this disclosure. The base station 301 guards RE patterns for an advanced UE in the presence of a legacy UE transmitting via a CSI-RS port.

In case of CSI-RS port transmission, CSI-RS ports can be low power. Using the similar RE muting principles for CRS case, FIGS. 12A and 12B show two patterns that provide multiple choices to balance the interference reduction and data RE loss. In FIG. 12A, the first pattern 1200 (CSI-1) includes two adjacent (dark shaded) RES for every CSI RE (light shaded, marked with a value R₁₅-R₂₃). In FIG. 12B, the second pattern 1201 (CSI-2) includes one adjacent (dark shaded) RES for every CSI RE (light shaded, marked with a value R₁₅-R₂₃).

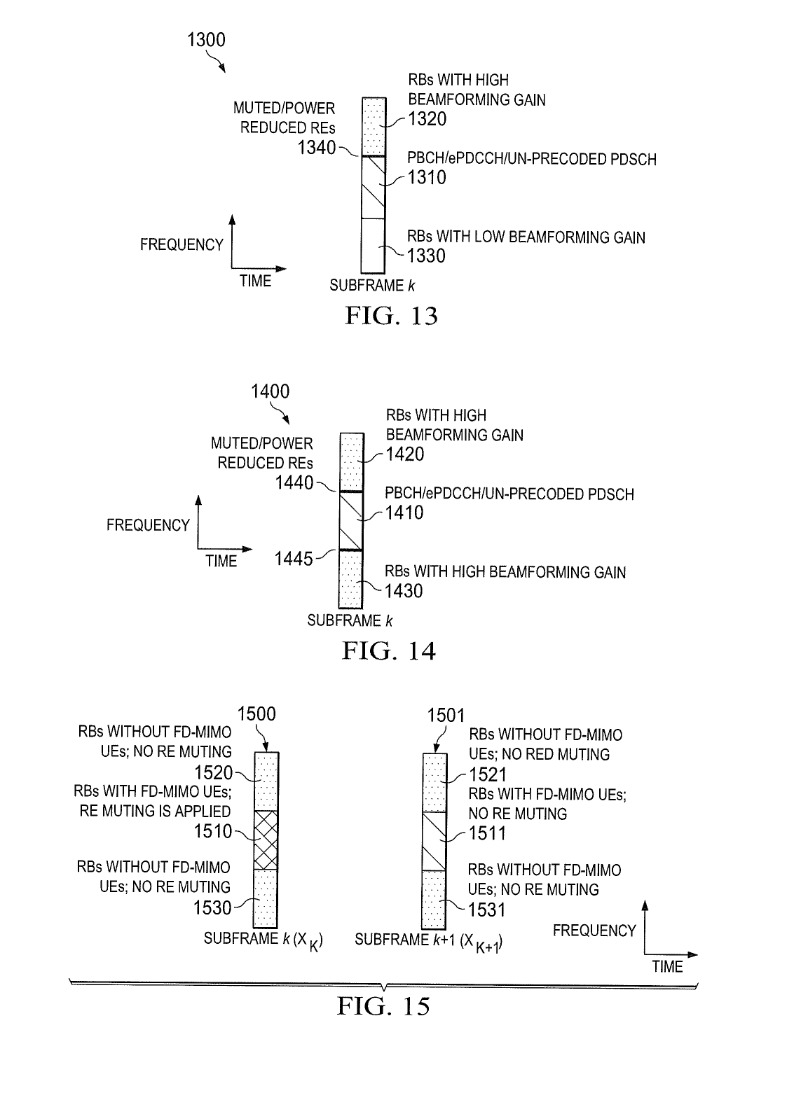

FIGS. 13 and 14 illustrate examples of guard RE patterns of a subframe (k) for high beamforming resource blocks according to embodiments of the present disclosure. The embodiments of the guard RE patterns shown in FIGS. 13 and 14 are for illustration only. Other embodiments could be used without departing from the scope of this disclosure.

The guard RE patterns in FIGS. 13 and 14 are applicable to the cases where one side of the low power RBs is adjacent to the high power RBs or both sides of the low power RBs are adjacent to the high power RBs. Regarding RE guarding patterns for PBCH and other channels: when broad beamwidth-low beamforming gain PBCH/ePDCCH/PDSCH is transmitted along with narrow beamwidth-high beamforming gain PDSCH, the base station 301 selects to mute or reduce power of the subcarriers in the boundary of the high power RBs to the low power RBs. That is, the base station 301 mutes or reduces the power for a subset of REs adjacent to some reference signals (e.g., CRS, CSI-RS). The guard RE patterns of the present disclosure mitigate interference for signals having critical reference elements transmitted to legacy UEs, improves reception based on CRS of legacy UEs in close proximity to advanced UEs, and improves channel measurement based on CSI-RS of legacy UEs in close proximity to advanced UEs. The guard RE patterns protect legacy UEs from severe interference attributable to proximity to advanced UEs 311-312.

FIG. 13 illustrates a subframe of a single UE having a guard RE pattern for one-sided high beamforming RBs. The subframe 1300 (k) includes a low power resource block 1310 (for example, PBCH, ePDCCH, or PDSCH) having two adjacent resource blocks that have low and high beamforming gains. Applicable examples include when PBCH reception is co-scheduled with precoded PDSCH; the ePDCCH reception is co-scheduled with precoded PDSCH; the unprecoded PDSCH reception is co-scheduled with precoded PDSCH for other UES; or the PSS detection is in FDD. On one side, the low power resource block 1310 is adjacent to the RB 1320 with high beamforming gain. On the other side, the low power resource block 1310 is adjacent to the RB 1330 with low beamforming gain. For example, RB 1320 is on the higher frequency side of the low power resource block 1310, and RB 1330 is on the lower frequency side of RB 1310. Within the RB 1320 with high beamforming gain, the boundary high power resource elements 1340 that are adjacent to the low power RB 1310 can cause severe interference to the boundary low power resource elements within the RB 1310. The base station 301 implements a RE guard pattern for the low power channel by muting or reducing the power of boundary high power resource elements 1340 that are adjacent to the low power RB 1310.

FIG. 14 illustrates a subframe having a guard RE pattern for two-sided high beamforming RBs. The subframe 1400 shows the cases where both sides of the low power RBs 1410 are adjacent to the high power RBs 1420 and 1430 with high beamforming gains. For example, high power RB 1420 is on the higher frequency side of the low power resource block 1410, and high power RB 1430 is on the lower frequency side of RB 1410. The base station 301 implements a RE guard pattern for the low power channel by muting or reducing the power of boundary high power resource elements 1440 that are adjacent to the REs of the higher frequency side of the low power RB 1410, and by muting or reducing the power of boundary high power resource elements 1445 that are adjacent to the REs of the lower frequency side of the low power RB 1410.

### eNB Configurations of Guard RE Pattern

FIG. 15 illustrates an example fixed RE muting and an example dynamic RE muting according to embodiments of the present disclosure. The embodiment of the RE muting shown in FIG. 15 is for illustration only. Other embodiments could be used without departing from the scope of this disclosure.

The subframe 1500 (Xₖ) includes resource blocks 1510 for communication with advanced UEs. For example, the RBs 1510 can be precoded (dark shading) with high beam forming gain and subject to having RE muting applied. The higher frequency side of the RBs 1510 is adjacent to RBs 1520 without reference elements for communication with advanced UEs. The lower frequency side of the RBs 1510 is adjacent to RBs 1530 without reference elements for communication with advanced UEs. For example, the RBs 1520 and 1530 can be unprecoded (light shading) and not subject to having RE muting applied.

The subframe 1501 (Xₖ+₁) includes resource blocks 1511 for communication with advanced UEs. For example, the RBs 1511 can be precoded (dark shading) with high beam forming gain, but not subject to having RE muting applied. The higher frequency side of the RBs 1511 is adjacent to RBs 1521 without reference elements for communication with advanced UEs. The lower frequency side of the RBs 1511 is adjacent to RBs 1531 without reference elements for communication with advanced UEs. For example, the RBs 1521 and 1531 can be unprecoded (light shading) and not subject to having RE muting applied. That is, no RE muting is applied in subframe 1501 (Xₖ₊₁).

The base stations 301 of present disclosure not only implement RE muting within a guard RE pattern, but also implement RE power reduction. RE muting can be applied to a variety of RE guarding configurations, including: semi-static RE muting configurations, and dynamic RE muting configurations. RE power rejection can be applied alone or in jointly with RE muting.

In one example, when an advanced UE is scheduled with a FD-MIMO transmission scheme, RE guarding is applied to the corresponding PDSCH. In subframe 1500 (Xₖ), for all the RBs that are assigned to one or more advanced UEs, one of the RE guarding patterns specified in FIGS. 10A-12B is applied.

In another example, eNB 301 can configure whether or not an advanced UE (for example, advanced UEs 311 or 312) should expect RE guarding for FD-MIMO PDSCH.

In another example, eNB 301 can indicate 2-bit information to an advanced UE regarding which one of 3 different patterns is selected for RE guarding. For example, the three different patterns can include a CRS port 1 guard pattern, a CRS port 2 guard pattern, and CSI-RS port 1 guard pattern.

These semi-static configurations can be configured by a higher layer (e.g., RRC). Semi-static RE guarding configurations can change from REs from a muted state to an unmuted state in approximately 1 second. Dynamic RE guarding configurations can change from REs from a muted state to an unmuted state in approximately a millisecond, which is 1000 times faster than semi-static configurations. More specifically, the methods for implicit configuration include: (1) an implicit configuration by transmission scheme, or (2) an implicit configuration by transmission mode. In the case of implicit configuration by transmission scheme, an advanced UE assumes RE guard pattern is transmitted is a certain transmission scheme is scheduled. In the case of implicit configuration by transmission mode, an advanced UE assumes RE guard pattern is transmitted is a certain transmission mode is configured.

The methods for explicit RRC configuration include: (1) one bit to indicate whether RE muting is ON or OFF, or (2) two bits to indicate whether RE muting is on or off, and if on, which pattern is used. Using a one bit indicator, for example, 0 indicates that RE guard pattern is not used, and 1 indicates that RE guard pattern is used. Using a two bit indicator, for example, Table 2 defines which pattern is used, if any.

TABLE 2
2-bit RE Muting Indication

| State of the | | | |
|---|---|---|---|
| 2-bit field | CRS port 1 | CRS port 2 | CSI-RS port |
| 00 | Off | Off | Off |
| 01 | 1P-1 in FIG. 10A | 2P-1 in FIG. 11A | CSI-1 in FIG. 12A |
| 10 | 1P-2 in FIG. 10B | 2P-2 in FIG. 11B | CSI-2 in FIG. 12B |
| 11 | reserved | reserved | reserved |

In dynamic configurations: in one example, eNB 301 can indicate 1-bit information to an advanced UE regarding whether or not an advanced UE should expect RE guarding for FD-MIMO PDSCH. This indication can be signaled dynamically in a DCI format.

In another example, eNB 301 can signal 2-bit information (e.g., as in Table 2) to an advanced UE to indicate which one of three different RE guarding patterns that the UE should expect. This indication can be signaled dynamically in a DCI format.

The dynamic configurations improve the spectrum efficiency by reducing the number of subframes applying RE muting. That is, instead of completely muting the REs according to the patterns in FIGS. 10A-12B, the base station 301 implements RE power reduction methods such that the powers of these guard REs are reduced and the ratio of the powers are configured.

In the case of RE Power Reduction alone, for the advanced UE, the power of the guard REs in the RE guard patterns are reduced by a certain dB with respect to the other PDSCH REs in the RB. The power reduction in dB can be signaled according to Table 3, where these two bits information can be signaled via a higher layer.

TABLE 3
RE Power reduction indication

| | | |
|---|---|---|
| | Power ratio of guard | Power ratio of guard |
| State of | REs to the other PDSCH | REs to the other PDSCH |
| the 2-bit field | REs (dB) - Alt 1 | REs (dB) - Alt 2 |

| | | |
|---|---|---|
| 00 | 0 | −3 |
| 01 | −3 | −6 |
| 10 | −6 | −9 |
| 11 | −9 | −∞ (the guard REs are |
| | | muted) |

In the case of Joint RE Muting and Power Reduction, a 2-bit field indicates a selected RE guarding pattern as well as a RE power level. Two examples of such indication are provided below in Tables 4 and 5. Table 4 is an example of the joint indication for the case of 1 CRS port. Table 5 is an example of the joint indication for the case of 2 CRS ports.

TABLE 4
Joint RE guarding pattern and power reduction indication (1 CRS port)

| | Power ratio of guard | |
|---|---|---|
| State of the 2-bit | REs to the other | |
| field | PDSCH REs (dB) | RE guard pattern |
| 00 | −3 | 1P-2 |
| 01 | −6 | 1P-2 |
| 10 | −9 | 1P-1 |
| 11 | −∞ (the guard REs | 1P-1 |
| | are muted) | |

TABLE 5
Joint RE guarding pattern and power reduction indication (2 CRS ports)

| | Power ratio of guard | |
|---|---|---|
| | REs to the other | |
| State of the 2-bit field | PDSCH REs (dB) | RE guard pattern |
| 00 | −3 | 2P-2 |
| 01 | −6 | 2P-2 |
| 10 | −9 | 2P-1 |
| 11 | −∞ (the guard REs | 2P-1 |
| | are muted) | |

Tables 3 and 4 show that: if a denser RE guarding pattern is used, the legacy UEs may suffer from severe ICI so that the base station 301 needs to reduce more power for guard REs. On the other hand, if a less dense RE guarding pattern is used, the legacy UEs may suffer from mild ICI so that the base station 301 may not need to reduce much power for guard REs.

### eNB Implementation by Considering Guard RE Pattern

The impact of interference in the presence of high power dynamic range can also be mitigated by some specific eNB implementations without changing the current 3GPP LTE standard. These specific eNB implementations include a power control implementation, and an RE blanking implementation.

In the power control implementation the eNB reduces transmit power used for some selected RBs, which may have a much higher receive power at a UE compared with adjacent RBs that carry desired information for the UE. By reducing the transmit power of the selected RBs, the receive power dynamic range across RBs can be reduced, improving the robustness for interference avoidance.

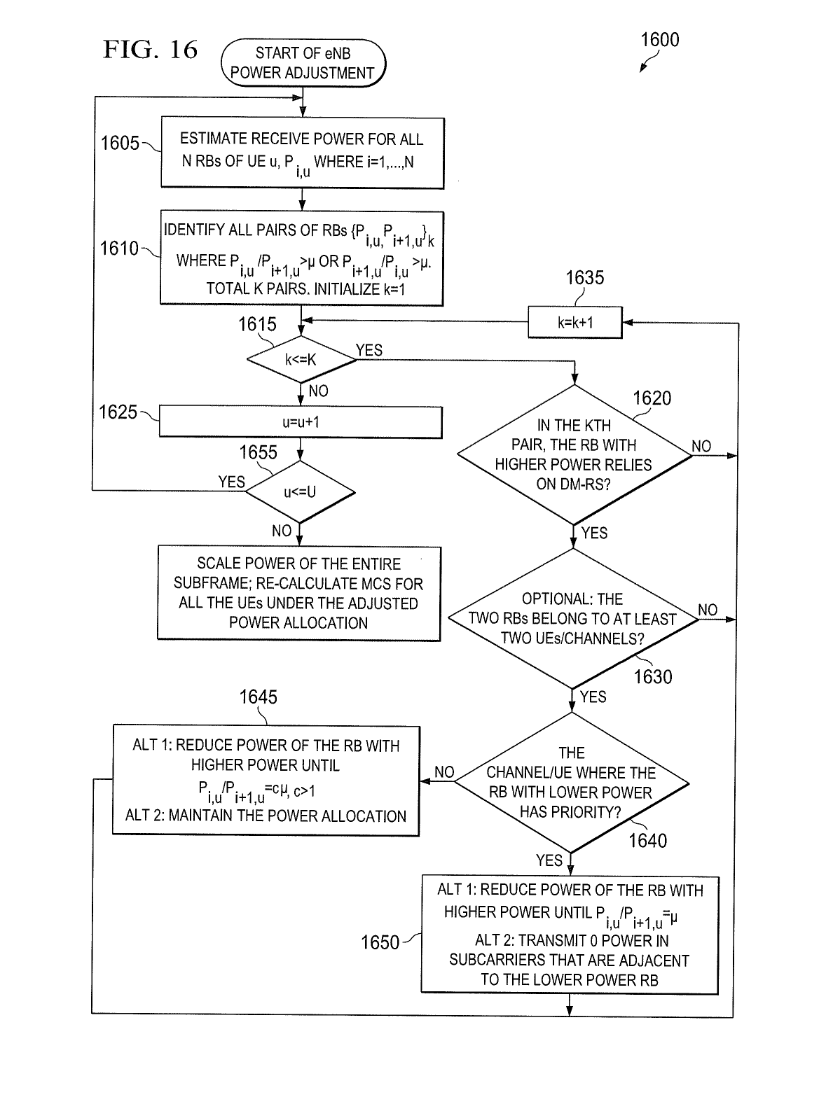

FIG. 16 illustrates an example block diagram of a power control implementation and a RE guarding implementation according to embodiments of the present disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a base station. All the decision blocks are used in the implementations (for example, checking whether two RBs belong to the same UE/channel).

In block 1605, the eNB receives a UE's feedback report on channel quality indicator (CQI) and precoding matrix indicator (PMI) (in frequency division duplexing (FDD)) or estimating uplink channels based on SRS sounding signals (in time division duplexing (TDD)). The eNB calculates MCS level based on PMI (or SRS channel estimation), CQI and power allocation for UEs. The eNB estimates received power for all RBs from the UE's perspective. The power is denoted as P₁, where the RB index or counter is i=1, . . . , N and N is the total number of RBs in use, and where the user index or counter is U and U is the total number of UEs within the cell of the eNB.

In block 1610, the eNB identifies all pairs of consecutive 2 RBs {P_{i,u}, P_{i+1, u}}ₖ, where

$$\frac{{P}_{i , u}}{{P}_{i + 1 , u}} > μ or \frac{{P}_{i + 1 , u}}{{P}_{i , u}} > μ .$$

The total number of pairs is K, and the count of pairs is initialized as k=1. In block 1610, the eNB identifies the problematic RB pairs, where adjacent RBs have an intolerable power dynamic range.

In block 1615, the eNB determines whether the current pair of RBs is the last of the total number (K) of consecutive RBs. If the count (k) for the current pair of RBs is not the last pair, then the method continues to block 1620. If the eNB determines that the count (k) for the current pair of RBs is the last pair, then the method continues to block 1625, where the eNB increments the UE counter (u) by one (i.e., u=u+1).

In block 1620, the eNB analyzes the k^{th} pair of consecutive RBs by determining whether the RB with higher power relies on DM-RS. If the RB with higher power relies on DM-RS (e.g., a critical reference signal relied upon by advanced UEs), then the method continues to block 1630. Else, the method continues to block 1635, where the index counter (k) is incremented by one (k=k+1) and then returns to block 1615. In block 1620, the eNB determines whether the u^{th} UE is an advance UE, such as UE 311-312, or a legacy user equipment, such as UE 321-322. The method continues from block 1620 to block 1635 upon a determination that the u^{th} UE is legacy UE.

In block 1630, the eNB determines whether the k^{th} pair of consecutive RBs belong to at least two UEs or at least two channels. If so, the method continues to block 1640. If not, the method continues to block 1635, where the index counter (k) is incremented by one (k=k+1) and then returns to block 1615. No adjustments to the power level is made if the pair of RBs belong to the same UE and the same channel.

In block 1640, the eNB analyzes either the channel or the UE to which both RBs of the k^{th} pair belong by determining whether the channel/UE where the RB with lower power has higher priority. If the lower power RB does not have higher priority, then the method continues to block 1645. If the lower power RB has higher priority, then the method continues to block 1650.

In blocks 1650, the eNB selects to reduce the power of the higher power RB until

$$\frac{{P}_{i , u}}{{P}_{i + 1 , u}} = μ or$$

selects to transmit zero power in subcarriers that are adjacent to the lower power RB having higher priority. Next, the method continues to block 1635.

In block 1645, if the UE/channel to which the higher power RB has higher priority than the UE/channel to which the lower power RB belongs, then the eNB reduces the power such that the resulting modulation and coding scheme (MCS) remains unchanged for the high priority UE/channel. The eNB can select to reduce the power of the higher power RB until

$$\frac{{P}_{i , u}}{{P}_{i + 1 , u}} = c μ$$

for c>1. The coefficient c denotes a multiplier by which overhead is reducible without compromising performance of the higher priority channel or higher priority UE. Next, the method continues to block 1635.

In block 1655, after the eNB has incremented the counter index (u) for the UEs, the eNB determines whether the current UE (i.e., uₜₕ UE) is the last UE of the total number (U) of UEs within the cell of eNB 301. If the uₜₕ UE is last (i.e., u=U), then the method moves to block 1660. If the uₜₕ UE is not last (i.e., u<U), then the method moves to block 1605.

In block 1660, eNB scales up the power of the entire subframe. The eNB recalculates the MCS for all of the UES under the adjusted power allocation.

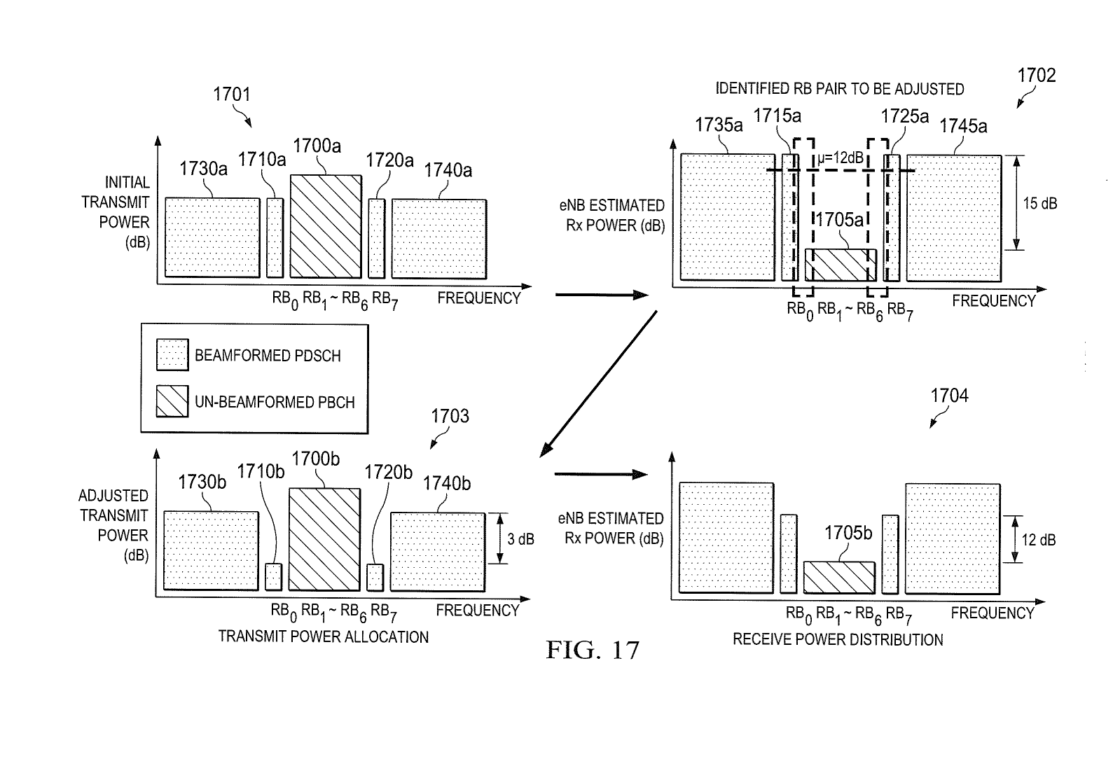

FIG. 17 illustrates an example of power control for different channels considering ICI according to embodiments of the present disclosure. The embodiment of the power control shown in FIG. 17 is for illustration only. Other embodiments could be used without departing from the scope of the present disclosure.

In cases of more than one UE scheduled in the high power RB, there will be multiple ways of reduce the total transmit power of this RB. For example, eNB can select to only reduce the power of the UE having precoders that cause the highest receive power.

The graph 1700 shows that the un-beamformed PBCH 1710a (shown by dark shading) and the beamformed PDSCH 1710a, 1720a, 1730a, 1740a collectively (shown by light shading) are transmitted to the same UE.

The graph 1702 shows that eNB analyzes the received power distribution and determines that the power dynamic range between the first pair of RBs (RB₀ and RB₁) is 15 dB, which is the same for the second pair of RBs (RB₆ and RB₇). That is, the received power of the beamformed PBCH 1715a, 1725a, 1735a, 1745a is 15 dB greater than the received power of the broad beamwidth-low beamforming gain PBCH 1705a. By comparing the power dynamic range to a threshold value μ=12 dB, the eNB determines that the transmit power of RB₀ and RB₇ should be reduced to mitigate ICI to the broad beamwidth-low beamforming gain PBCH 1705a.

The graph 1703 shows that the eNB reduces the transmit power in the RBs 1710b and 1720b (RB₀ and RB₇) adjacent to the center PBCH channel 1700b (RB₁-RB₆) by a certain dB (e.g., 3 dB). This will not impact the UE demodulation for the PDSCH, as the channel estimation is performed via the DM-RS within a RB having power that is also reduced.

In this case, the graph 1704 shows that the SNR of the REs in the PBCH 1705b can be approximately improved by 3 dB.

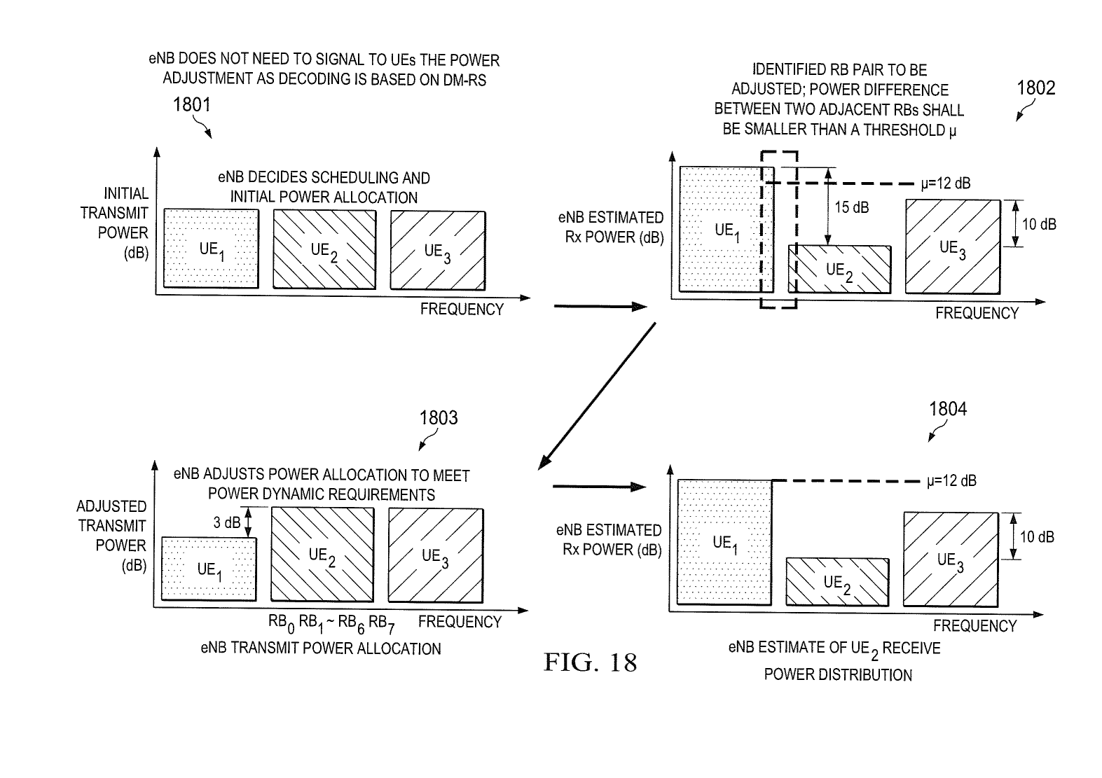

FIG. 18 illustrates an example of power control for different UEs considering ICI according to embodiments of the present disclosure. The embodiment of the power control shown in FIG. 18 is for illustration only. Other embodiments could be used without departing from the scope of the present disclosure.

The graph 1801 shows that the eNB schedules UE₁ and UE₂ in adjacent RBs where UE₁'s PDSCH is beamformed with high beamforming gain while UE₂'s PDSCH is not beamformed (e.g., or beamformed with low beamforming gain). In addition, the eNB determines that UE₁ and UE₂ are in a similar direction (thus similar channel directions) based on the PMI feedback or SRS channel estimation. Accordingly, the precoders/beamformers used for UE₁ will also beamform to UE₂ as well. In case of ideal frequency synchronization there will be no issue, as UE₁ and UE₂ are orthogonal in frequency. The graph 1802 shows that the frequency error may cause the interference to leak from the RBs assigned for UE₁ to UE₂, where the receive power in UE₁ is much larger than the receive power in UE₂ (a similar situation discussed in reference to graph 1702 of FIG. 17). As the received power for the UE₃ is 10 dB greater than the received power for UE₂, which is less than the threshold value μ=12 dB, the UE2 can correctly decode its signals despite mild interference from UE₃.

The graph 1803 shows that the eNB can reduce the adjacent RB of UE₁ to UE₂ by a certain e.g. 3 dB. The graph 1804 shows that as a result of the 3 dB transmit power reduction at UE₁, the power dynamic range between UE₁ and UE₂ changes from an intolerable 15 dB to a tolerable 12 dB. That is, from UE₂'s perspective, the receive power attributable to the UE₁ for is tolerable.

From a system perspective, the eNB select to switch between the RB power reduction described here and the RE guarding method described above, assuming the standard supports the signaling of RE guard pattern. The eNB calculates the effective rate.

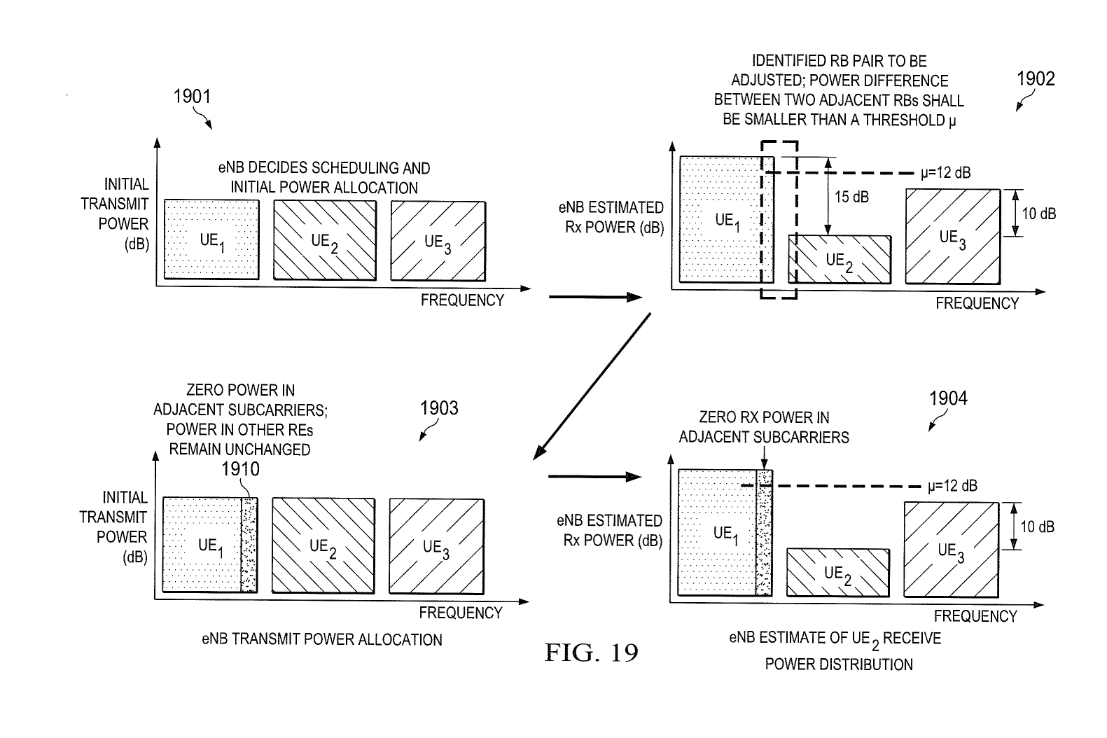

FIG. 19 illustrates an example of an RE blanking implementation according to embodiments of the present disclosure. The embodiment of the RE blanking shown in FIG. 19 is for illustration only. Other embodiments could be used without departing from the scope of the present disclosure.

In the RE blanking implementation, eNB nulls the subcarriers of a high power RB that are adjacent to a low power RB. After the RE muting, the eNB selects whether or not to adjust the MCS level of the TB index of the high power UE, because it is realistic to assume the presence of at least some redundancy in the transmission.

In graph 1901, the eNB receives UEs' feedback report on CQI and PMI (in FDD) or estimating uplink channels based on SRS sounding signals (in TDD). The eNB calculates MCS level based on PMI (or SRS channel estimation), CQI and power allocation for UEs. The eNB estimates the receive power for all RBs from the UE's perspective. The power is denoted as Pᵢ, where i=1, . . . , N and N is the total number of RBs in use.

In graph 1902, the eNB identifies all pairs of consecutive 2 RBs, where

$$\frac{{P}_{i}}{{P}_{i + 1}} > μ or \frac{{P}_{i + 1}}{{P}_{i}} > μ .$$

As shown, although the maximum tolerable dynamic power range is set to a threshold value μ=12 dB, the received power for UE₁ is 15 dB greater than the received power for UE₂. The received power for the UE₃ is 10 dB greater than the received power for UE₂, which corresponds to a tolerable amount of interference smaller than the threshold value μ.

Graph 1903 shows that if the UE/channel (UE₁) to which the higher power RB belongs has lower priority than the UE/channel (UE₂) to which the lower power RB belongs, then eNB nulls subcarriers 1910 in the higher power RB that are adjacent to the lower power RB (UE₂). The eNB scales up the power of the entire subframe. The eNB recalculates the MCS for all the UEs.

The graph 1904 shows that the subcarriers of higher priority UE₁ that are adjacent to the lower priority UE₂ are muted to a zero receive power level, while the remaining subcarriers of the higher priority UE₁ are received at a power level that exceeds the threshold value μ=12 dB. That is, the non-adjacent subcarriers of higher priority UE₁ produce a dynamic power range of 15 dB between UE₁ and UE₂.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method comprising:
identifying at least one pair of adjacent resource blocks within a same subframe, the at least one pair including a low power resource block (RB) and a high power RB, wherein the low power RB has a substantially lower beamforming gain compared to the high beamforming gain of the high power RB such that a ratio (R) comparing receive powers of the high power RB and the low power RB to each other is greater than a threshold ratio (μ); and
reducing a transmit power of the high power RB to a reduced transmit power level at which the ratio R is less than or equal to the threshold ratio μ (R≦μ), and
transmitting zero power at REs of the high power RB that are adjacent to the low power RB.

2. The method of claim 1, wherein reducing the transmit power of the high power RB to the reduced transmit power level further comprises:
in response to determining that the high power RB belongs to a first user equipment (UE₁) and that the low power RB belongs to a second user equipment (UE₂), reducing the transmit power of the UE₁'s high power RB to the reduced transmit power level.

3. The method of claim 1, wherein reducing the transmit power of the high power RB to the reduced transmit power level further comprises:
in response to determining that the high power RB belongs to a first channel and that the low power RB belongs to a second channel, reducing the transmit power of the first channel's high power RB to the reduced transmit power level.

4. The method of claim 1, wherein reducing the transmit power of the high power RB to a reduced transmit power level further comprises:
muting REs in the high power RB that are adjacent to the low power RB to zero power.

5. The method of claim 1, wherein reducing the transmit power of the high power RB to the reduced transmit power level further comprises:
in response to determining that the low power RB has a higher priority than the high power RB, reducing the transmit power of the high power RB to the reduced transmit power level.

6. The method of claim 1, wherein the reduced transmit power level is determined by one of two equations:
$$R = \frac{{P}_{i}}{{P}_{i + 1}} and R = \frac{{P}_{i + 1}}{{P}_{i }} ,$$
where Pᵢ represents an estimate of receive power of an i^{th} RB, where Pᵢ₊₁ represents an estimate of receive power of an adjacent (i+1)^{th} and where i represents an index counter for all RBs of a subframe.

7. A base station comprising:
processing circuitry configured to:
identify at least one pair of adjacent resource blocks within a same subframe, the at least one pair including a low power resource block (RB) and a high power RB, wherein the low power RB has a substantially lower estimate of receive power compared to the high power RB such that a ratio (R) comparing receive powers of the high power RB and the low power RB to each other is greater than a threshold ratio (μ), and
reduce a transmit power of the high power RB to a reduced transmit power level at which the ratio R is less than or equal to the threshold ratio μ (R≦μ), and
control a transmitter to transmit zero power at REs of the high power RB that are adjacent to the low power RB; and
the transmitter configured to transmit a signal using the reduced transmit power level.

8. The base station of claim 7, wherein the processing circuitry is further configured to:
in response to determining that the high power RB belongs to a first user equipment (UE₁) and that the low power RB belongs to a second user equipment (UE₂), reduce the transmit power of the UE₁'s high power RB to the reduced transmit power level.

9. The base station of claim 1, wherein the processing circuitry is further configured to:
in response to determining that the high power RB belongs to a first channel and that the low power RB belongs to a second channel, reducing the transmit power of the first channel's high power RB to the reduced transmit power level

10. The base station of claim 7, wherein the processing circuitry is further configured to:
in response to determining that the low power RB has a higher priority than the high power RB, reducing the transmit power of the high power RB to the reduced transmit power level.

11. The base station of claim 7, wherein the processing circuitry is further configured to reduce the transmit power of the high power RB to a reduced transmit power level by muting resource elements in the high power RB that are adjacent to the low power RB to zero power.

12. The base station of claim 7, wherein the reduced transmit power level is determined by one of two equations:
$$R = \frac{{P}_{i}}{{P}_{i + 1}} and R = \frac{{P}_{i + 1}}{{P}_{i}} ,$$
where Pᵢ represents a transmit power of an i^{th} RB, where Pᵢ₊₁ represents a transmit power of an adjacent (i+1)^{th} RB, and where i represents an index counter for all RBs of a subframe.

13. The base station of claim 7, wherein the high power RB is a precoded RB and the low power RB is an unprecoded RB.

14. A method comprising:
identifying at least a first subframe (k), wherein each identified subframe includes a first resource block (RB) having high beamforming gain;
configuring an user equipment (UE) whether to expect a resource element guarding pattern to be ON or OFF in each RB in the first subframe.

15. The method of claim 14, further comprising configuring the UE whether to expect a resource guarding pattern in each RB in a second subframe (k+1) next following the first subframe;
configuring the advanced user UE to expect a resource guarding pattern to be ON in the RB of the first subframe;
configuring the advanced user UE to expect a resource guarding pattern to be OFF the RB of the in the second subframe.

16. The method of claim 14, wherein configuring the advanced UE whether to expect resource element guarding pattern in a channel comprises:
an implicit configuration by transmission scheme, wherein the advanced UE assumes an RE guarding pattern based on a scheduled transmission scheme;
an implicit configuration by transmission mode, wherein the advanced UE assumes an RE guarding pattern based on a configured transmission mode.

17. The method of claim 14, wherein configuring the advanced UE whether to expect resource element guarding pattern in a channel comprises one of:
transmitting one bit of information to indicate whether an RE guarding pattern is ON or OFF; and
transmitting at least two-bits of information to the advanced UE indicating whether an RE guarding pattern is OFF and if ON, further indicating a selected RE guarding pattern, selected from a plurality of RE guarding patterns.

18. The method of claim 17, wherein the plurality of RE guarding patterns include three different guarding patterns, including:
a CRS port 1 RE guarding pattern,
a CRS port 2 RE guarding pattern, and
a CSI-RS port 1 RE guarding pattern.

19. The method of claim 14, wherein configuring an advanced user equipment (UE) whether to expect resource element guarding pattern in a channel comprises:
using higher layer signal including a radio resource control (RRC) protocol layer.

20. The method of claim 14, further comprising transmitting a power reduction indicator to the advanced UE indicating a power ratio of the first RB, the power ratio being a transmit power of guard resources element (REs) compared to a transmit power of other Physical Downlink Shared Channel (PDSCH) REs within the first RB.

21. The method of claim 20, wherein the power ratio is infinitely negative (−∞) yielding muted guard REs having a zero value transmit power.

22. The method of claim 20, wherein the power reduction indicator includes at least two-bits of state information, and
wherein the two-bits indicate a selected power ratio according to the table below:

| State of the 2-bit field | Power ratio |
|---|---|
| 00 | 0 |
| 01 | −3 |
| 10 | −6 |
| 11 | −9 |

23. The method of claim 20, wherein the power reduction indicator includes at least two-bits of state information, and
wherein the two-bits indicate a selected power ratio according to the table below:

| State of the 2-bit field | Power ratio |
|---|---|
| 00 | −3 |
| 01 | −6 |
| 10 | −9 |
| 11 | −∞ |

24. The method of claim 14, wherein configuring the advanced UE whether to expect resource element guarding pattern in a channel comprises transmitting at least two-bits of state information, the at least two-bits including at least one bit indicating a selected RE guarding pattern and at least another bit indicating a power ratio of the first RB.
